(19) United States
(12) Patent Application Publication
(10) Pub. No.: US 2004/0040993 A1
(43) Pub. Date: Mar. 4, 2004

(54) Means for securing a hydration pack to a motorcycle fuel tank

(76) Inventor: Daryl Eric Spratley, Reno, NV (US)

Correspondence Address: DARYL E. SPRATLEY, 2766 DANBURY COURT, RENO, NV, 89523, US

(21) Appl. No.: 10/394,375

(22) Filed: Mar. 21, 2003

Related U.S. Application Data
(60) Provisional application No. 60/407,311, filed on Sep. 3, 2002.

(51) Int. Cl. B62J 7/00; B62J 9/00; B62J 11/00

(52) U.S. Cl. 224/413; 224/414

(57) ABSTRACT

An arrangement for securing a commercially available hydration pack to a motorcycle which provides for easy access to the fluid in the hydration pack by the motorcycle rider. The hydration pack maintains its original functionality, yet is quickly attached to the motorcycle fuel tank top planar area in front of the rider with use of quick connect fastener elements and nylon web strapping materials. This system of attachment straps and connectable fasteners along with methods for attaching these straps and fasteners to a hydration pack and a motorcycle result in the hydration pack being securely, yet removably mounted to the motorcycle fuel tank area.

### CROSS REFERENCE TO RELATED APPLICATIONS

This application is based on provisional application serial No. 60/407311, filed on Sep. 3, 2002.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of motorcycle accessories and more specifically to a means for securing a hydration pack to a motorcycle fuel tank, comprised of straps, buckles and fastening devices.

This invention relates to portable, backpack style hydration packs and the use of said pack while seated on a motorcycle. Motorcycles are generally used in fair to warm weather and are used daily around the world in a working capacity. Working in warm weather demands the consumption of fluids to stay hydrated and avoid heat related illnesses. A motorcycle, due to its limited size may not have sufficient cargo area to carry an ample amount of water for proper hydration. Additionally, cargo areas are generally located behind the rider and are not easily accessed.

The commercially available hydration packs usually consist of a flexible plastic bladder for which to fill with fluid, a rubber tube and valve from which to draw the fluid from the bladder, and a pack with shoulder straps to allow for the carrying of the pack on the users person. Hydration packs can hold a greater amount (generally around 100 oz.) of easily portable, readily accessible fluid than other portable beverage containers, and are available in insulated form. While the hydration pack tends to be designed for comfort while worn on the users back, the riding position of having the arms extended forward can lead to the pack becoming uncomfortable, especially during extended wearing. It would not be practical for some users to wear a hydration pack while riding for many reasons such as safety, comfort and uniform compatibility, so a means for having the hydration pack secured to the unused top area of the motorcycle fuel tank is contemplated.

There are many styles of tank mounted cargo bags available for motorcycles. These however are designed to carry cargo and tend to be bulky. Not an option for a person performing daily work on a motorcycle due to repeated dismounts and re-mounting of the motorcycle during a shift. Also, carrying a fluid container in a motorcycle cargo area requires that the rider open the cargo area, retrieve the container, and open it to access the fluid. The heat buildup in an uninsulated cargo area warms the hydration fluid container, resulting in a decreased satisfaction upon consuming the fluid. The hydration pack, however, requires that the consumer merely pick up the tube and activate the valve (usually by mouth) to access the fluid. Many of the hydration packs available have openings large enough to accommodate the filling of ice with the fluid, resulting in a cool beverage for consumption.

There are a number of styles of hydration packs as well. One should be selected to provide the maximum amount of fluid needed with the least amount of bulk. A preference for this invention is a hydration pack which is backpack style with shoulder straps. The upper shoulder straps need to be separable from the lower straps.

U.S. Pat. No. 4,359,233 to Jackson et al. is an example of a type of commercially available motorcycle tank bag which can be quickly attached to and removed from a motorcycle fuel tank area. Per the illustrations and descriptions, this tank mounted cargo bag appears large in capacity and size.

U.S. Pat. No. 4,274,566 to Rowe and U.S. Pat. No. 5,201,442 to Bakalianare examples of devices to provide hydration to riders of bicycles, motorcycles and other vehicles, and there are other variations of mounted hydration systems, whether mounted to the vehicle or rider, which have been invented.

The current invention is of new use, with no known prior art, in that it is not a cargo container, nor a hydration apparatus, but rather a means for having an already developed, commercially available hydration pack mountable and removable from a motorcycle without compromising the usefulness and functionality of the pack in its original form. The current invention provides that a hydration pack may be minimally and not adversely modified so as to be easily mounted and as easily removed from a motorcycle, to be used again in its original design as a backpack style hydration pack.

The motorcycle tank bag of U.S. Pat. No. 4,359,233 appears as a well designed and easily removable cargo container, of which a hydration pack may certainly be considered for such cargo. The relative size of a majority of tank mounted cargo bags, or of a cargo bag containing a hydration pack would lend to an undesirable bulk and design complexity, as well as additional cost to the consumer. Not a desirable option for persons needing a streamline pack or for person performing daily work on a motorcycle due to repeated mounts and dismounts of the motorcycle. The present invention removes the unnecessary bulkiness by simply using the hydration pack itself as the unit to be secured to the motorcycle. The hydration apparatuses of U.S. Pat. Nos. 4,274,566 and 5,201,442 correctly address the issue of much needed hydration requirements while operating vehicles, especially vehicles where the operator is exposed to the environmental elements. While these named inventions lend themselves to be mounted to bicycles they may indeed be modified to motorcycle use, but have an undesirable complexity in design and appear to be limited in their portability. The current invention is not a hydration device, but rather a cost effective means for having a popular, proven, simple and available hydration pack mounted to a motorcycle, thus fulfilling the need for hydration while providing removability and as designed use of the pack.

### BRIEF SUMMARY OF THE INVENTION

The primary object of the invention is that it provides a means for attaching a hydration pack to a motorcycle fuel tank.

Another object of the invention is that it provides for the rider to be free from an encumbering pack yet have access to hydration.

Another object of the invention is that it allows for the hydration pack to be easily accessed.

A further object of the invention is that the hydration pack is located in front of the rider and is centered for stability.

Yet another object of the invention is that the hydration pack is easily and quickly removable and useable in its original fashion.

Still yet another object of the invention is there are no adverse modifications to pack.

Further still another object of the invention is that it is simple and cost effective in design.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a means for securing a hydration pack to a motorcycle fuel tank top planar area comprising: a plurality of fastener elements and materials joined to create attachment means, a system of attachment straps and connectable fastener means, a system of alternative mounting means, a method for attaching straps and fasteners to a hydration pack, a method for attaching straps fasteners and alternative mounting means to said motorcycle and, a method of connecting hydration pack straps and fasteners to motorcycle straps and fasteners resulting in said hydration pack being securely, yet removably mounted to said motorcycle.

In accordance with a preferred embodiment of the invention, there is disclosed Hydration pack of claim 1 being of a commercially available backpack style, having shoulder straps, of which said straps are usually differentiated by the upper strap being formed into or attached to a wider and padded area which is generally integrated into said pack upper portion design, and the lower strap being of a strapping material and separable from said upper strap by means of a slide, buckle or other element, and securely attached to the lowest portion of said pack.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan view of the invention mounting strap and connector assembly.

FIG. 2 is a plan view of the invention in relative attachment to a backpack style hydration pack.

FIG. 3a is an elevational view of the invention and hydration pack in position to be mounted to a motorcycle.

FIG. 3b is an elevational view of the invention and hydration pack in relative mounted position on a motorcycle.

FIG. 4a is a perspective view of a motorcycle fuel tank and dash area and approximate location of available body panel screws for mounting the invention.

FIG. 4b is a perspective view of a motorcycle fuel tank and dash area with the invention mounted in place.

FIG. 5a is an elevational view of the alternative mounting invention as mounted on a motorcycle fuel tank.

FIG. 5b is a perspective view of an alternative mounting element of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

In accordance with the present invention, the accompanying drawings show various means for securing a commercially available backpack style hydration pack to the top planar area of a motorcycle fuel tank, of which said fuel tank area is generally located above the motorcycle engine and frame, behind the steering area and in front of the riders seat. Such mounting means are realized by utilizing a plurality of fastener elements and materials joined to create the following attachment arrangements.

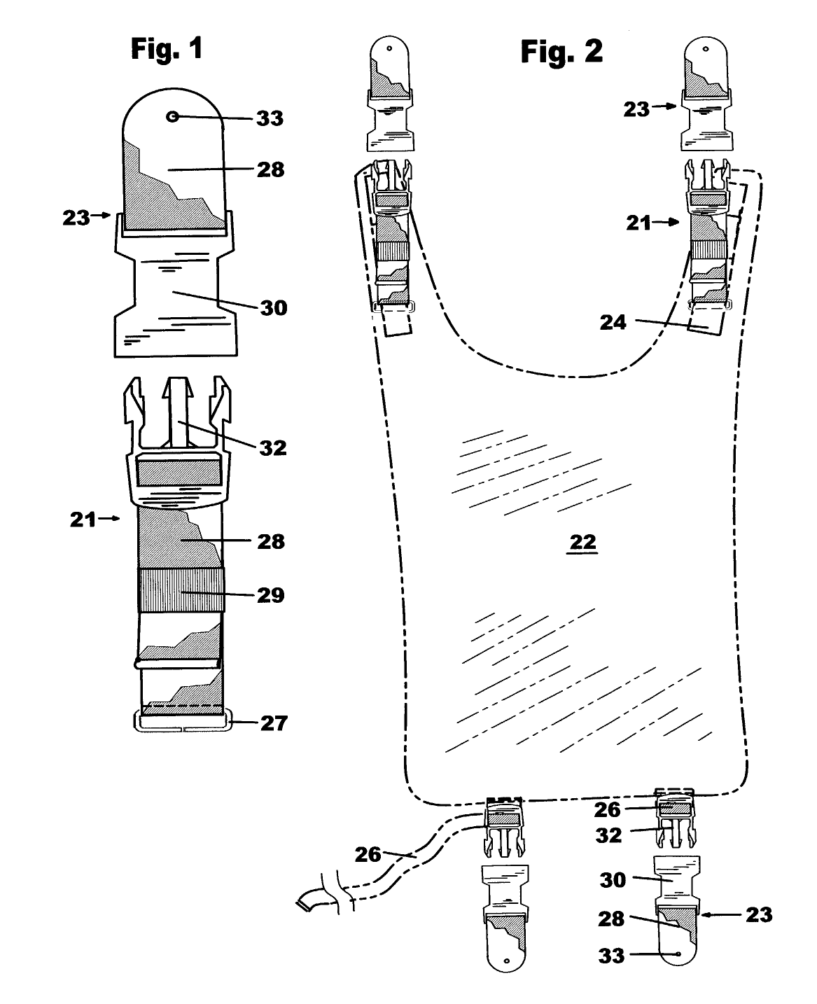

By way of illustration of the present invention, FIG. 1 shows an enlarged plan view of a preferred embodiment comprising a system of commercially available side release buckles attached to nylon web material. The female connector assembly (23) has a preferred connectable element of a female side release buckle end (30) and has an aperture (33) of a given size formed into the web material (28) opposing end for receiving a body panel mounting screw or other available fastener. The male connector assembly (21) has a preferred connectable element of a male side release buckle end (32), which mates with female end (30). Assembly (21) forms the adjustable portion of the strapping assembly and is made by weaving one end of a given length of web material (28) through the openings of the male connector (32), and the remaining end of material (28) being fashioned, preferably by being folded and attached back on itself, so as to form a small loop at the end of the web material. A metal hoop (27), loop or other strong connector hardware such as a small gated spring hook is slid through the loop in the web material (28). A small form of elastic band (29) or other suitable banding may be placed over the assembly (21) to retain the excess web material after adjustment.

FIG. 2 is a plan view of the outer or “face side” of a backpack style hydration pack (22). In the illustrated embodiment, upper shoulder strap (24) is usually differentiated from the lower strap (26) in that the upper strap (24) is formed into or attached to a wider and padded area of material which is generally integrated into the pack design. Said lower strap (26) being attached to the lowest portion of pack (22) and preferably separable from upper strap (24) usually by means of a slide, buckle or other element. The preferred embodiment shows right and left upper shoulder straps having assembly (21) attached with loop (27) as installed by sliding an available section of upper shoulder strap (24) through opening in loop and positioning loop so that strap assembly (21) may lay forward toward lead edge of upper shoulder strap. The lower shoulder straps (26) are removed from the upper straps (24) by divorcing them from the appropriate connector used on the given pack or by cutting the lower shoulder strap away if sewn to the upper strap. The male side release connectors (32) are attached to lower straps (26) by weaving said straps through the respective connector (32) and sliding the connector to the base of the hydration pack. The lower shoulder straps (26) may be re-attached to the upper shoulder straps via the original attachment means, or simply gathered and bound in a form of banding so as to be secure. In the instance of the lower strap (26) being cut from the upper strap (24), the two may be re-connected for use as a backpack configuration by sliding connector (32) far enough up on strap (26) so as to be connected to assembly (21). Further examination of FIG. 2 shows the strapping assemblies (23) in relative position to be connected to strapping assemblies (21).

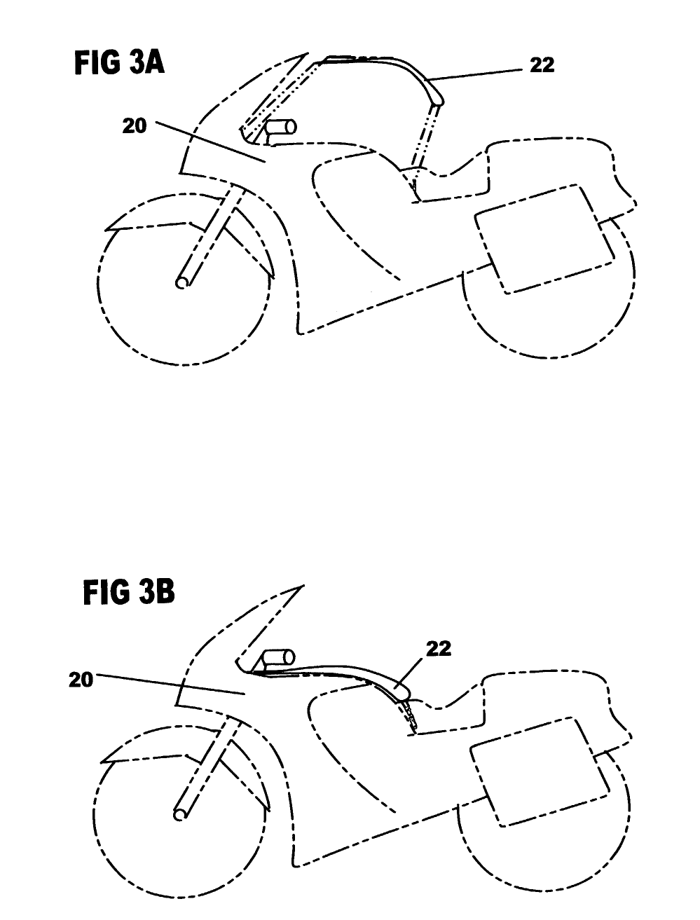

FIG. 3a is an elevation view of the motorcycle (20) with the hydration pack (22) in relative position to be mounted on the motorcycle fuel tank top. The pack (22) is positioned face up, backside down and upper shoulder straps forward.

FIG. 3b is an elevation view of the motorcycle (20) with the hydration pack (22) in the mounted position on the tank top. The pack is positioned face up, backside down and upper shoulder straps forward.

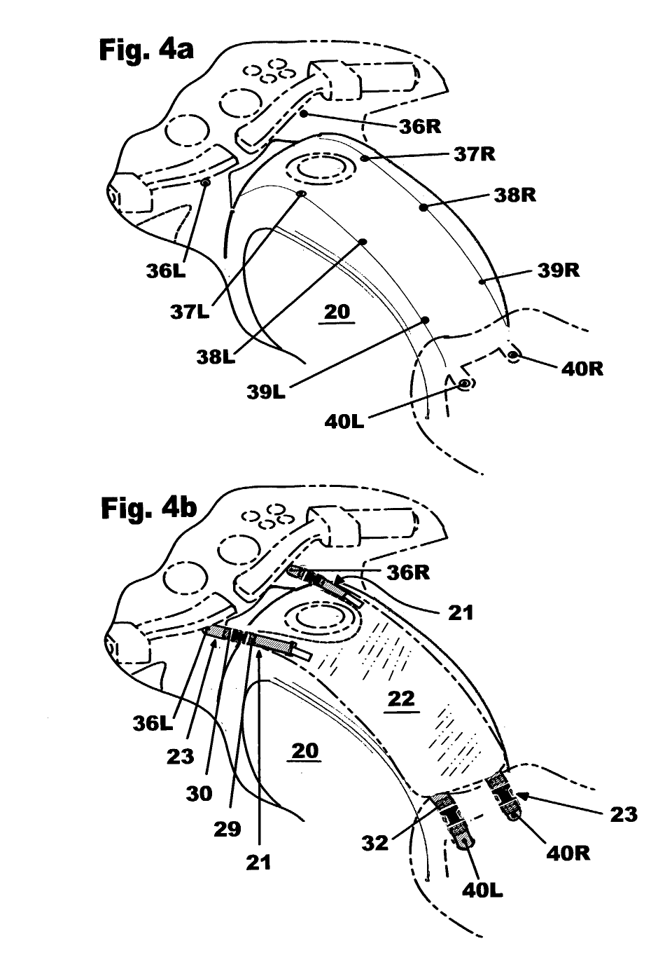

FIG. 4a is a perspective view of the preferred design of motorcycle (20) dash/handlebar area and fuel tank area. The dash of this motorcycle has two lower dash screws (36L, 36R) in front of the handlebars below the gauges. There are also two body panel screws located at the most forward portion of the fuel tank top (37L, 37R), two rearward of the fuel filler door (38L, 38R), two near the rearward edge of the tank top (39L, 39R), and two beneath the riders' seat (40L, 40R).

FIG. 4b is a perspective view of the preferred design of motorcycle (20) dash/handlebar area and fuel tank area. The preferred method in which the female connector assemblies (23) are fastened to the dash is by locating and removing screws (36L, 36R), inserting the screws through their respective apertures (33) in the strapping material, and reinstalling the screws into the dash with assemblies (23) securely attached. The preferred method in which the connector assemblies (23) are fastened to the area beneath the seat is by removing the screws (40L, 40R), inserting the screws through their respective apertures (33) in the strapping material, and replacing the screws into the removed location with assemblies (23) securely attached. The pack base male ends (32) are then locked into place by connecting them to assemblies (23) beneath the seat area. The pack (22) is then laid forward, backside down across the top planar area of the motorcycle fuel tank with strap assemblies (21) extended forward, subsequently locking the connectors (32) to the connectors (30) in assemblies (23) mounted on the dash. To restrain the hydration pack (22) against vertical and lateral movement the user pulls the excess web material (28) in assembly (21) until strapping is taught and pack (22) is tight against motorcycle tank surface. Excess web material may be secured under banding (29). Of importance is that the hydration pack drink tube (not shown) may be routed so as to be readily accessible by the rider, and may be secured by means provided with the pack or by simply tucking the tube under either taught upper shoulder strap.

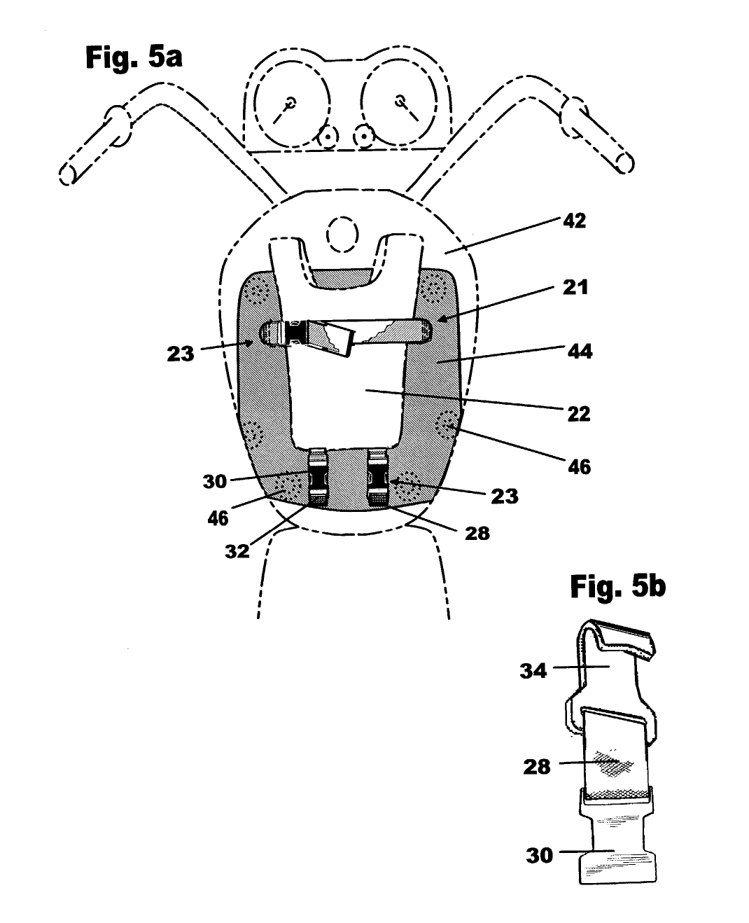

FIG. 5a is an elevational view of a motorcycle handlebar area and fuel tank (42) area with an alternative mounting means which comprises a magnetic base hydration pack mount (44) on the top surface of the tank. The magnets (46) are attached to the pad material base (44) by various means such as stitching or gluing and are enclosed by other durable material. The mounting straps (28) on assemblies (23) are then attached to the base (44) via various means such as stitching, rivets, or snaps and are positioned strategically to correspond with male fastener elements (32) at base of pack (22) to provide for secure mounting of the pack to the magnetic base (44). Additionally, a lateral strap assembly (21 and 23) should be secured to the base (44) by various means of securing the web strapping to the base material. The pack (22) has male connector ends (32) applied to the lower shoulder straps (26), per FIG. 2, with the upper shoulder straps (24) re-connected to the lower straps (26). The pack (22) is then secured to the base (44) by connecting the male connector ends (32) at the base of the pack to the female strap ends (30) on the base (44). The pack (22) is then placed backside down over the magnetic base and is secured with mounting strap assembly (21 and 23) placed laterally across the hydration pack, with male/female connectors fastened.

FIG. 5b is a perspective view of an alternative and universal fastening arrangement, consisting of the strapping material (28) and female fastener end (30) with a j-type hook or gutter hook (34) attached. The j-hook (34) may be attached either permanently by stitching or by use of locking slides along the strapping material to form an alternative to assembly (23). The j-hooks can then be secured to the flat metal seam found under some motorcycle fuel tanks, or to any rigid flat edge or body panel lip on the motorcycle which would accommodate the j-hook and provide for adequate tension to secure the mounting strap.

Other attachment considerations of importance are that in addition to or replacement of the j-hooks, other means may be used such as hook and loop tape, double sided tape, “Dual Lock” tape, magnets, etc. attached to the strap assembly ends to secure the strap ends to the motorcycle. Referring to FIG. 1, an alternative for loop (27) on assembly (21), not shown in the illustrations may be the application of a clamping or cam buckle device attached to the loop end of assembly (21) to attach the assembly to the upper shoulder strap area of a pack not having an upper shoulder strap as described in these embodiments.

The removal of the hydration pack from the motorcycle requires the simple effort of squeezing the outboard prongs of the male connector elements (32) on the attachment arrangements and sliding the connector elements (32 and 30) apart, thereby releasing the pack (22) from the motorcycle tank area.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A means for securing a hydration pack to a motorcycle fuel tank top planar area comprising:
a plurality of fastener elements and materials joined to create attachment means;
a system of attachment straps and connectable fastener means;
a system of alternative mounting means;
a method for attaching straps and fasteners to a hydration pack;
a method for attaching straps fasteners and alternative mounting means to said motorcycle and;
a method of connecting hydration pack straps and fasteners to motorcycle straps and fasteners resulting in said hydration pack being securely, yet removably mounted to said motorcycle.

2. Hydration pack of claim 1 being of a commercially available backpack style, having shoulder straps, of which said straps are usually differentiated by the upper strap being formed into or attached to a wider and padded area which is generally integrated into said pack upper portion design, and the lower strap being of a strapping material and separable from said upper strap by means of a slide, buckle or other element, and securely attached to the lowest portion of said pack.

3. Connectable fastener elements of claim 1 comprising a preferred embodiment of side-release buckle with the female end attached to a given length of nylon web strapping and said strapping having an aperture of a given size at opposing end for receiving a mounting screw.

4. Connectable fastener elements of claim 1 comprising a preferred embodiment of side-release buckle with the male end attached to a given length of nylon web strapping and said strapping being fashioned at the opposing end for receiving a form of loop hardware to attach to material on said hydration pack, right and left shoulder straps, furthermore having a form of banding over said nylon web strapping arrangement to secure excess strapping after adjustment.

5. Fastener elements of claim 1 comprising a preferred embodiment of side-release buckle, male end, attached to said lower, removed, right and left shoulder straps of said hydration pack.

6. Alternative mounting means of claim 1 comprising a preferred embodiment of J-type gutter hooks attached to said aperture end of said nylon web strapping of claim 3, and/or a clamping or cam buckle type device attached to the loop end of strapping assembly of claim 4.

7. Another alternative mounting means of claim 1 comprising:
a preferred embodiment of magnets attached to a pad material of a given size for laying on said planar surface of a metal motorcycle fuel tank and having a durable material of relative size sewn over said pad material so as to enclose said magnets within, and to allow said strapping of claim 3 and 4 to be sewn at said aperture ends, laid laterally across said durable material so as to receive a hydration pack to be secured by said male and female fastener elements, with two fastener elements of claim 3 sewn at lowest edge of durable material so as to correspond and receive male fastener elements attached to said lower shoulder straps of said hydration pack.

8. Method for attaching said straps and fasteners to said hydration pack of claim 1 comprising:
removal of said upper shoulder straps of said hydration pack from said lower shoulder straps;
threading left lower shoulder strap through male fastener end of claim 5 and sliding said fastener to the base of said pack then re-attaching lower shoulder strap to upper shoulder strap, or securing excess strapping in banding;
threading right lower shoulder strap through male fastener end of claim 5 and sliding said fastener to the base of said pack then re-attaching lower shoulder strap to upper shoulder strap, or securing excess strapping in banding;
attaching said loop of strap assembly of claim 4 to web support material on left upper shoulder strap of said pack and;
attaching said loop of strap assembly of claim 4 to web support material on right upper shoulder strap of said pack.

9. A method for attaching straps fasteners and alternative mounting means to said motorcycle comprising:
locating a body panel or similar screw or fastener on the dash area of a given motorcycle for the purpose of removal and reinstallation upon placing said screw or fastener through the aperture opening of strapping assembly of claim 3;
locating a body panel or similar screw or fastener below the riders seat area of a given motorcycle for the purpose of removal and reinstallation upon placing said screw or fastener through the aperture opening of strapping assembly of claim 3;
utilizing the J-hook strap assembly of claim 6 to attach to the forward and rearward lip area of a motorcycle fuel tank or similar lip on body panel if no mounting screw can be located or;
utilizing said magnetic mount assembly of claim 7 if preferred or necessary, by simply placing said mount onto the top planar area of a metal motorcycle fuel tank.

10. A method of connecting hydration pack straps and fasteners to motorcycle straps and fasteners of claim 1 comprising:
the insertion of the male side-release buckle ends on said hydration pack lower shoulder straps into female side-release buckle ends at rear of fuel tank or riders seat area;
the laying of said hydration pack assembly forward and across said top planar area of the motorcycle fuel tank area, extending said mounting straps of claim 4 forward toward said mounting straps of claim 3 which are fastened to the dash area as in claim 9, and joining said side release buckles of these two fasteners together and;
pulling the excess strap material of the upper shoulder strap fastener arrangements of claim 3 to provide tension on the pack so as to provide stability of said pack on the motorcycle.
